(19) United States
(12) Patent Application Publication
(10) Pub. No.: US 2019/0213499 A1
(43) Pub. Date: Jul. 11, 2019

(54) INFORMATION PROCESSING APPARATUS, ARTIFICIAL INTELLIGENCE IDENTIFICATION METHOD, AND PROGRAM

(71) Applicant: CASIO COMPUTER CO., LTD., Shibuya-ku, Tokyo (JP)

(72) Inventor: Kazunori KITA, Tokyo (JP)

(73) Assignee: CASIO COMPUTER CO., LTD., Shibuya-ku, Tokyo (JP)

(21) Appl. No.: 16/330,351

(22) PCT Filed: Jun. 19, 2018
(86) PCT No.: PCT/JP2018/023346

§ 371 Date: Mar. 4, 2019

(30) Foreign Application Priority Data
Jun. 22, 2017 (JP) 2017-122535

(51) Int. Cl. G06N 20/00

(52) U.S. Cl. CPC G06N 20/00

(57) ABSTRACT

An information processing apparatus includes a processor and a memory. The processor executes a program stored in the memory to perform operations including identifying an artificial intelligence, and notifying a user of an identification result about the artificial intelligence.

### TECHNICAL FIELD

The present invention relates to an information processing apparatus, an artificial intelligence identification method, and a program.

### BACKGROUND ART

Conventionally, a technology of supporting a user by an artificial intelligence is known. For example, an assistant function is used in which the artificial intelligence searches information with respect to a question of the user, and presents a reply which is considered as being required by the user. The user is capable of using a function of an artificial intelligence which is mounted on a terminal device, or an artificial intelligence which is provided by a server. Furthermore, in Japanese Patent Application Publication No. 2016-536630 (Japanese Translation of PCT Application), a technology is disclosed in which a humanoid robot understands the words of the user, and has a conversation with the user. Here, recently, many types of artificial intelligences have been practically realized, and thus, the user is required to select an artificial intelligence suitable for the object from a plurality of artificial intelligences. However, it is difficult to suitably understand which artificial intelligence is an artificial intelligence which is an execution target.

The present invention has been made in consideration of such circumstances, and an object thereof is to suitably identify an artificial intelligence, and to suitably understand which artificial intelligence is an artificial intelligence which is an execution target.

According to the present invention, it is possible to suitably identify an artificial intelligence, and to suitably understand which artificial intelligence is an artificial intelligence which is an execution target.

This application is based on and claims the benefit of priority from Japanese Patent Application No. 2017-122535, filed on Jun. 22, 2017, the content of which is incorporated herein by reference.

### SUMMARY OF INVENTION

According to an aspect of the present invention, an information processing apparatus includes a processor and a memory, wherein the processor executes a program stored in the memory to perform operations including: identifying a communication-target artificial intelligence, from among a plurality of artificial intelligences; and notifying a user of an identification result about the communication-target artificial intelligence.

According to another aspect of the present invention, an information processing apparatus including a processor and a memory, wherein the processor executes a program stored in the memory to perform operations including: identifying a communication-target program, from among a plurality of programs for providing assistance to a user; and notifying the user of an identification result.

According to still another aspect of the present invention, an artificial intelligence identification method is executed by an information processing apparatus including a processor, and the artificial intelligence identification method causes the processor to execute a program stored in a memory to perform operations including: identifying a communication-target artificial intelligence, from among a plurality of artificial intelligences; and notifying a user of an identification result about the communication-target artificial intelligence.

According to still another aspect of the present invention, a non-transitory computer-readable storage medium storing a program that is executable by a computer that comprises a processor, the program being executable to cause the computer to perform operations including: identifying a communication-target artificial intelligence, from among a plurality of artificial intelligences; and notifying a user of an identification result about the communication-target artificial intelligence.

### BRIEF DESCRIPTION OF DRAWINGS

FIG. 1 is a block diagram illustrating a hardware configuration of an information processing apparatus according to one embodiment of the present invention.

FIG. 2 is a function block diagram illustrating a functional configuration for executing AI identification processing, in a functional configuration of the information processing apparatus of FIG. 1.

FIG. 3 is a schematic diagram illustrating an example of an AI authentication method table.

FIG. 4 is a flowchart describing a flow of the AI identification processing which is executed by the information processing apparatus of FIG. 1, having the functional configuration of FIG. 2.

### DESCRIPTION OF EMBODIMENTS

Embodiments of the present invention will be explained with reference to the drawings.

Hereinafter, an embodiment of the present invention will be described by using the drawings.

When a user uses an artificial intelligence (AI), an information processing apparatus according to the present invention identifies the artificial intelligence which is a communication partner, from the viewpoint of not only a name or a version, but also various attributes of the artificial intelligence. At this time, the information processing apparatus authenticates the artificial intelligence which is the communication partner, by a predetermined authentication method, and thus, identifies whether or not the artificial intelligence is an artificial intelligence which is assumed as the communication partner. Further, the information processing apparatus outputs an identification result about the artificial intelligence which is the communication partner, by a predetermined output method, and thus, notifies (presents) the user of (with) the identification result. Therefore, in the information processing apparatus according to the present invention, the user is capable of suitably identifying the artificial intelligence, and of suitably understanding which artificial intelligence is the artificial intelligence which is the execution target.

### Hardware Configuration

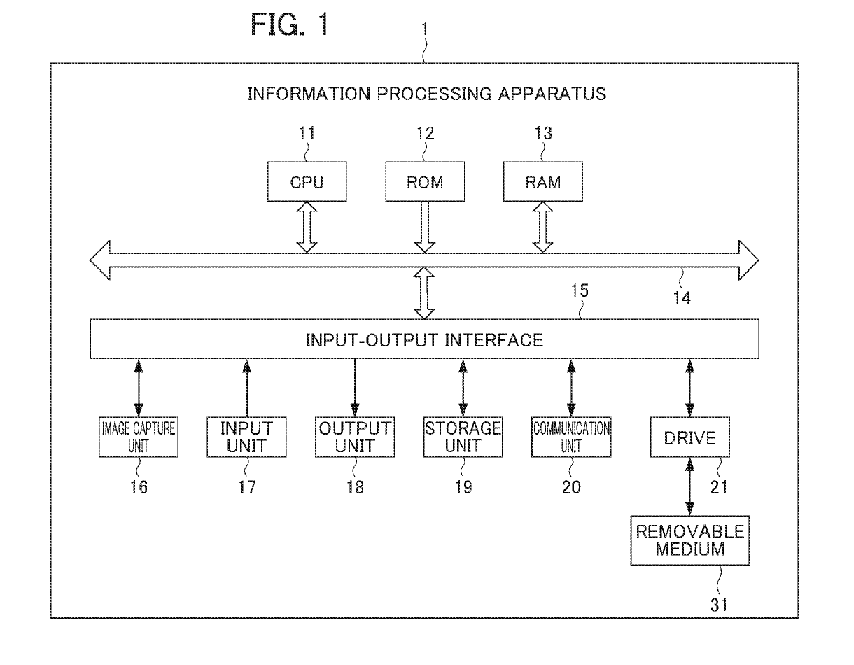

FIG. 1 is a block diagram showing a configuration of hardware of an information processing apparatus 1. For example, the information processing apparatus 1 is a smart phone.

As shown in FIG. 1, the information processing apparatus 1 includes a processor (CPU) 11, a read only memory (ROM) 12, a random access memory (RAM) 13, a bus 14, an input/output interface 15, an image capture unit 16, an input unit 17, an output unit 18, a storage unit 19, a communication unit 20, and a drive 21.

The processor 11 executes various types of processing according to a program stored in the ROM 12 or a program loaded from the storage unit 19 into the RAM 13.

Data and the like required by the processor 11 executing the various processing is stored in the RAM 13 as appropriate.

The processor 11, the ROM 12, and the RAM 13 are connected to each other via the bus 14. In addition, the input/output interface 15 is also connected to this bus 14. The input/output interface 15 is further connected to the image capture unit 16, the input unit 17, the output unit 18, the storage unit 19, the communication unit 20, and the drive 21. The image capture unit 16 includes an optical lens unit and an image sensor, which are not shown.

In order to photograph a subject, the optical lens unit is configured by a lens such as a focus lens and a zoom lens for condensing light. The focus lens is a lens for forming an image of a subject on the light receiving surface of the image sensor. The zoom lens is a lens that causes the focal length to freely change in a certain range. The optical lens unit also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is constituted by an optical sensor such as an optoelectronic conversion device of a CMOS (Complementary Metal Oxide Semiconductor) type. A subject image is incident upon the optoelectronic conversion device through the optical lens unit. The optoelectronic conversion device optoelectronically converts (i.e. captures) the image of the subject, accumulates the resultant image signal for a predetermined period of time, and sequentially supplies the image signal as an analog signal to the AFE. The AFE executes a variety of signal processing such as A/D (Analog/Digital) conversion processing of the analog signal. The variety of signal processing generates a digital signal that is output as an output signal from the image capture unit 16. The data of the captured image are provided to the processor 11 and an image processing unit and the like, not shown.

The input unit 17 is constituted by various buttons, and the like, and inputs a variety of information in accordance with instruction operations by the user. The output unit 18 is constituted by a display, a speaker, and the like, and outputs images and sound. The storage unit 19 is constituted by DRAM (Dynamic Random Access Memory) or the like, and stores various kinds of data. The communication unit 20 controls communication with a different apparatus via a network including the Internet.

A removable medium 31 composed of a magnetic disk, an optical disk, a magneto-optical disk, a semiconductor memory or the like is loaded in the drive 21, as necessary. Programs that are read via the drive 21 from the removable medium 31 are installed in the storage unit 19, as necessary. Like the storage unit 19, the removable medium 31 can also store a variety of data such as data of images stored in the storage unit 19.

### Functional Configuration

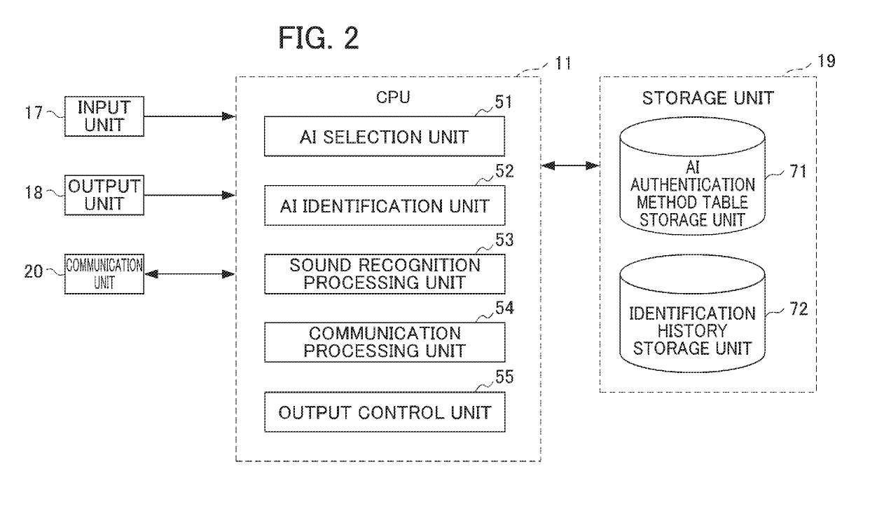

FIG. 2 is a function block diagram illustrating a functional configuration for executing AI identification processing, in a functional configuration of the information processing apparatus 1 of FIG. 1. The AI identification processing is a set of processings of identifying the artificial intelligence which is the communication partner, when the user uses a program assisting the user, such as an artificial intelligence, and of outputting the identification result in a mode which can be recognized by the user.

In a case where the AI identification processing is executed, as illustrated in FIG. 2, in a CPU 11, an AI selection unit 51, an AI identification unit 52, a sound recognition processing unit 53, a communication processing unit 54, and an output control unit 55 function. In addition, in one region of a storage unit 19, an AI authentication method table storage unit 71 and an identification history storage unit 72 are set.

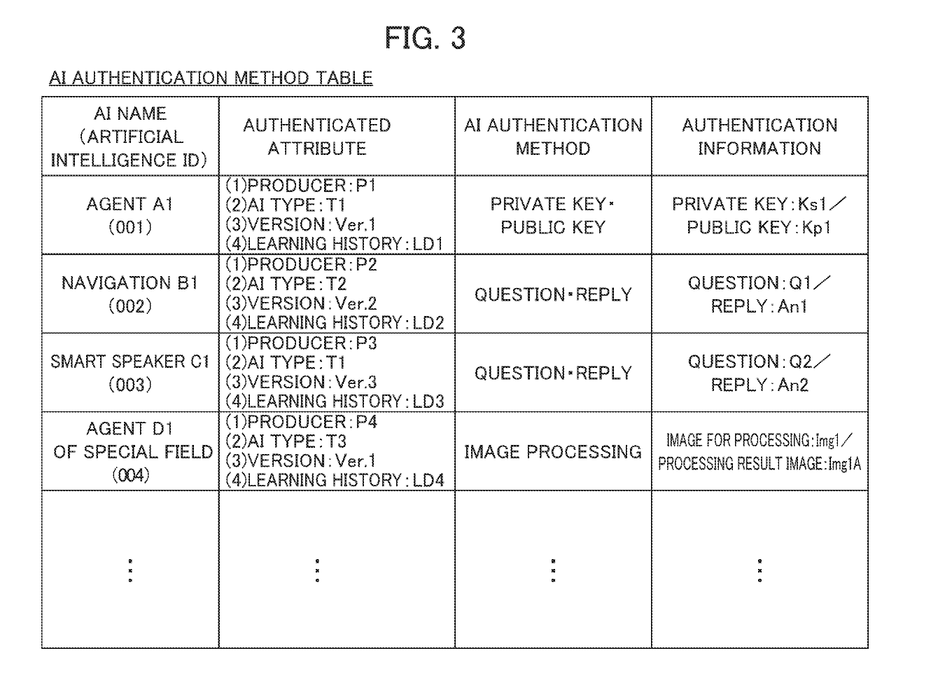

In the AI authentication method table storage unit 71, an AI authentication method table associated with predetermined information for authenticating the AI is stored. FIG. 3 is a schematic diagram illustrating an example of the AI authentication method table. As illustrated in FIG. 3, in the AI authentication method table storage unit 71, each data item of an AI name, an authenticated attribute, an AI authentication method, and authentication information is stored in association with a plurality of AIs.

The AI name indicates a name of an artificial intelligence which is an authentication target. In this embodiment, the name of the artificial intelligence indicates a system name of the artificial intelligence, and for example, can be a product name, a service name, or the like. In a case where the user nominates the artificial intelligence, in general, the AI name is used. Furthermore, in this embodiment, an ID indicating the artificial intelligence is set corresponding to the AI name.

The authenticated attribute indicates contents of an attribute which is authenticated in advance as the attribute of the artificial intelligence which is the authentication target. A producer, an AI type, a version, a learning history, and the like can be defined as the attribute of the artificial intelligence. The producer, for example, can be a developer of the artificial intelligence. The AI type, for example, can be an AI platform on which the artificial intelligence is based. The artificial intelligence based on the same AI platform is mounted on different devices, and thus, there is a case where different AT names are applied to the artificial intelligences, but the artificial intelligences can be classified to the same type, from the viewpoint of the AI type. The version, for example, can be a number indicating a revision stage of the artificial intelligence. The learning history, for example, an ID, a learning algorithm, or the like, indicating data which is used for learning by the artificial intelligence. Even in the same artificial intelligence, in a case where learning data or a learning algorithm is different, there is a possibility that the artificial intelligence outputs different results, and thus, in this embodiment, the learning history is defined as the attribute of the artificial intelligence.

The AI authentication method indicates a method of authenticating the artificial intelligence which is the authentication target. For example, authentication according to encoding using a private key and a public key can be used as the AI authentication method. In this case, in the artificial intelligence, a pair of the private key and the public key is generated in advance, and the public key is delivered to the information processing apparatus 1. In the information processing apparatus 1, a message combined with a session ID, date information, or the like is encoded by the public key, and is delivered to the artificial intelligence. In a case of the authenticated artificial intelligence, it is possible to decode the message from the information processing apparatus 1 by retaining the private key. In addition, the artificial intelligence encodes the message combined with the session ID, the date information, or the like, by the private key, and delivers the encoded message to the information processing apparatus 1. In a case of the message from the authenticated artificial intelligence, it is possible to decode the message by the public key in the information processing apparatus 1. In addition, the private key is retained only by the authenticated artificial intelligence, and thus, the message encoded by the private key has the meaning of an electronic signature of the authenticated artificial intelligence. Furthermore, in the information processing apparatus 1, the pair of the private key and the public key may be generated in advance, and the public key may be delivered to the artificial intelligence.

In addition, authentication using a private question and a reply which are agreed in advance between the artificial intelligence, which is the authentication target, and the user, can be used as the AI authentication method. In this case, the private question with respect to the artificial intelligence is set from the information processing apparatus 1, and the information processing apparatus 1 acquires in advance the reply with respect to the private question which is selected by the artificial intelligence. In a case where the artificial intelligence is authenticated, the private question is performed with respect to the artificial intelligence from the information processing apparatus 1, and thus, it is possible to determine whether or not it is the authenticated artificial intelligence, according to the reply.

In addition, it is possible to use authentication according to determination of a matching in the results in a case of allowing the artificial intelligence, which is the communication partner, to perform image processing with respect to a specific image (determination of whether or not the result is the same with the past image processing result). In this case, the specific image (an image for processing) is delivered to the artificial intelligence from the information processing apparatus 1, and the contents set in advance are subjected to the image processing. Furthermore, the image processing of the contents set in advance has a fixed width (a freedom degree of the processing result), and the information processing apparatus 1 acquires in advance an image processing result of the authenticated artificial intelligence. In a case where the artificial intelligence is authenticated, the information processing apparatus 1 allows the artificial intelligence to perform the image processing with respect to the specific image, and it is possible to determine whether or not it is the authenticated artificial intelligence according to whether or not the image processing result (a processing result image) matches with the image processing result acquired in advance. The authentication information indicates specific information which is used in the AI authentication method. For example, a pair of a private key Ks1 and a public key Kp1, a combination of a question Q1 and a reply An1, a combination of a specific image Img1 for authentication (an image for processing) and an image processing result (a processing result image Img1A), and the like can be stored as the authentication information.

In the identification history storage unit 72, the past identification history of the artificial intelligence which is the authentication target is stored. For example, date and time when each artificial intelligence was authenticated in the past, date and time when each of the artificial intelligences was not authenticated in the past, the contents of a change in the authenticated attribute, and the like can be stored as the identification history.

The AI selection unit 51 selects an artificial intelligence which performs communication with respect to the user, according to a manipulation of the user. At this time, in a case of performing a manipulation in which the artificial intelligence performing communication with respect to the user is directly designated by the user, the AI selection unit 51 selects the designated artificial intelligence. In addition, in a case where the user performs the manipulation which activates an application, the AI selection unit 51 selects an artificial intelligence which is linked to the application.

The AI identification unit 52 executes the AI authentication method defined in the AI authentication method table with respect to the artificial intelligence selected by the AI selection unit 51, with reference to the AI authentication method table. Then, the AI identification unit 52 determines whether or not a response from the artificial intelligence selected by the AI selection unit 51 matches with the authentication information of the artificial intelligence which was authenticated in the past (the authentication of the artificial intelligence). In a case where the response from the artificial intelligence selected by the AI selection unit 51 matches with the authentication information of the artificial intelligence which was authenticated in the past, the AI identification unit 52 identifies the artificial intelligence selected by the AI selection unit 51 as the authenticated artificial intelligence. The identification result is stored in the identification history storage unit 72, as the identification history. In addition, in a case where the response from the artificial intelligence selected by the AI selection unit 51 does not match with the authentication information of the artificial intelligence which was authenticated in the past, the AI identification unit 52 identifies the artificial intelligence selected by the AI selection unit 51, not as the authenticated artificial intelligence. Furthermore, in a case where the response from the artificial intelligence selected by the AI selection unit 51 does not match with the authentication information of the artificial intelligence which was authenticated in the past, the AI identification unit 52 specifies authentication failure information indicating mismatch with the authenticated attribute of the artificial intelligence which was authenticated in the past. The identification result is stored in the identification history storage unit 72 as the identification history.

In addition, in a case where authentication failure information indicating mismatch with the authenticated attribute of the artificial intelligence which was authenticated in the past, the AI identification unit 52 confirms the presence or absence of a change in the artificial intelligence with respect to a providing subject or an operating subject of the artificial intelligence (version up, a functional change, or the like) and the contents of the change. Then, in a case where it is confirmed that the change in the artificial intelligence is valid, the AI identification unit 52 updates the predetermined information for authenticating the AI, rewrites the AI authentication method table, and stores the contents of the change in the artificial intelligence in the identification history storage unit 72 as the identification history.

The sound recognition processing unit 53 recognizes a sound which is generated by the user to perform communication with respect to the artificial intelligence, and converts the sound into text data. The communication processing unit 54 performs processing relevant to communication between the user and the artificial intelligence which is the communication partner (the artificial intelligence identified by the AI identification unit 52). For example, the communication processing unit 54 outputs the text data converted by the sound recognition processing unit 53 to the artificial intelligence which is the communication partner. In addition, the communication processing unit 54 presents information input from the artificial intelligence which is the communication partner, according to a conversation flow.

The output control unit 55 outputs the information presented by the communication processing unit 54 (the contents of the communication between the user and the artificial intelligence) in a predetermined mode, on the basis of the identification result about the artificial intelligence of the AI identification unit 52. The output control unit 55 outputs the contents of communication between the user and the artificial intelligence which is identified by the AI identification unit 52, as the authenticated artificial intelligence, in a normal output mode (a standard output mode set in advance), as an example. On the other hand, the output control unit 55 outputs the contents of communication between the user and the artificial intelligence which is not identified by the AI identification unit 52, as the authenticated artificial intelligence, in an output mode different from the normal output mode. For example, it is possible to set a display mode of a display screen to be different from a normal mode, a vocal sound or an accent of the sound to be different from a normal mode, or a font of a displayed character to be different from a normal mode, as the output mode different from the normal output mode. The contents are output in the output mode different from the normal output mode, and thus, the user is capable of obviously recognizing that the artificial intelligence with which the user communicates, is not identical to the artificial intelligence with which the user generally communicates.

### Operation

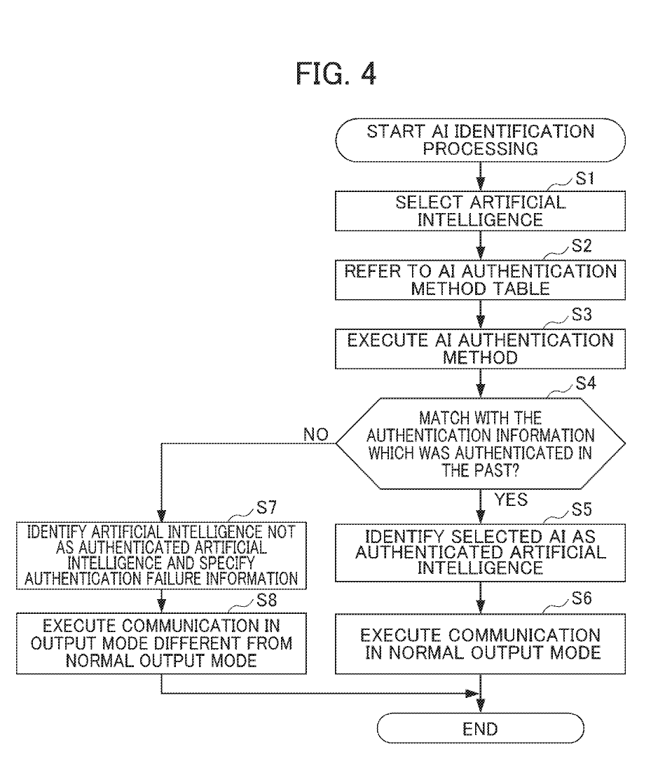

Next, an operation of the information processing apparatus 1 will be described. FIG. 4 is a flowchart describing a flow of the AI identification processing which is executed by the information processing apparatus 1 of FIG. 1, having the functional configuration of FIG. 2. The AI identification processing is executed in a case of performing communication with respect to the artificial intelligence in the information processing apparatus 1.

In step S1, the AI selection unit 51 selects the artificial intelligence performing communication with respect to the user, according to the manipulation of the user. In step S2, the AI identification unit 52 refers to the AI authentication method table. In step S3, the AI identification unit 52 executes the AI authentication method defined in the AI authentication method table, with respect to the artificial intelligence selected by the AI selection unit 51.

In step S4, the AI identification unit 52 performs determination of whether or not the response from the artificial intelligence selected by the AI selection unit 51 matches with the authentication information of the artificial intelligence which was authenticated in the past (the authentication of the artificial intelligence). In a case where the response from the artificial intelligence selected by the AI selection unit 51 matches with the authentication information of the artificial intelligence which was authenticated in the past, it is determined as YES in step S4, and the processing proceeds to step S5. On the other hand, in a case where the response from the artificial intelligence selected by the AI selection unit 51 does not match with the authentication information of the artificial intelligence which was authenticated in the past, it is determined as NO in step S4, and the processing proceeds to step S7.

In step S5, the AI identification unit 52 identifies the artificial intelligence selected by the AI selection unit 51 as the authenticated artificial intelligence. In step S6, the output control unit 55 outputs communication contents between the user and the artificial intelligence, which is the communication partner, in the communication processing unit 54, in the normal output mode.

In step S7, the AI identification unit 52 identifies the artificial intelligence selected by the AI selection unit 51 not as the authenticated artificial intelligence. In addition, at this time, the AI identification unit 52 specifies the authentication failure information indicating mismatch with the predetermined information of the artificial intelligence which was authenticated in the past. In step S8, the output control unit 55 outputs the communication contents between the user and the artificial intelligence, which is the communication partner, in the communication processing unit 54, in the output mode different from the normal output mode.

After step S6 and step S8, the AI identification processing is ended corresponding to the end of communication with respect to the artificial intelligence selected by the AI selection unit 51. Furthermore, in step 7 of the AI identification processing, in a case where the artificial intelligence selected by the AI selection unit 51 is identified not as the authenticated artificial intelligence, the AI identification unit 52 is capable of confirming the presence or absence of the change in the artificial intelligence with respect to the providing subject or the operating subject of the artificial intelligence (version up, a functional change, or the like) and the contents of the change, according to an instruction of the user or automatically. In a case where it is confirmed that the change in the artificial intelligence is valid, the predetermined information for authenticating the AI is updated, the AI authentication method table is rewritten, and the contents of the change in the artificial intelligence are stored in the identification history storage unit 72 as the identification history.

According to such processing, it is possible to identify whether or not the selected artificial intelligence is the artificial intelligence which is assumed as the communication partner of the user. In addition, the identification result about the artificial intelligence, which is the communication partner, is output by the predetermined output method, and thus, notification can be provided to the user. Therefore, according to the information processing apparatus 1, the user is capable of suitably identifying the artificial intelligence, and of suitably understanding which artificial intelligence is the artificial intelligence which is the execution target.

That is, conventionally, it is general that the user grasps the artificial intelligence by the name or the providing source, but even in a case where the names or the providing sources are the same, the artificial intelligences are not necessarily the same. For example, even in the artificial intelligences of which the names or the providing sources are the same, in a case where the same question is performed with respect to the artificial intelligences mounted on different terminal devices, there is a case where different replies are obtained. Further, there is also a possibility that the artificial intelligence which is recognized by the user as the communication partner, is substituted with the other artificial intelligence or the like by hacking or the like, and in this case, it is important for the user to determine whether or not the artificial intelligence is valid. On the contrary, according to the information processing apparatus 1 of this embodiment, the user is capable of identifying the artificial intelligence, and of suitably understanding which artificial intelligence is the artificial intelligence which is the execution target.

### Modified Example 1

In the embodiment described above, a case of identifying the artificial intelligence, which is the communication partner, in a case where the user who is a person, performs communication with respect to the artificial intelligence, has been described as an example. On the contrary, the present invention can also be applied to a case where the user who is the artificial intelligence, performs communication with respect to another artificial intelligence. When an artificial intelligence X as an assistance mounted on the information processing apparatus 1 possessed by the user, uses a service according to an artificial intelligence Y provided by a shopping site, the artificial intelligence X is capable of identifying the artificial intelligence Y, and of notifying the user of the identification result, as an example. Accordingly, even in a case where the artificial intelligence Y of the shopping site is an invalid artificial intelligence Z by hacking or the like, it is possible for the artificial intelligence X to identify the artificial intelligence of the communication partner, and to suppress suffering damage such as a deceit.

### Modified Example 2

In the embodiment described above, an area of specialty of the artificial intelligence may be acquired, and the user may select the artificial intelligence which is the communication partner, from the plurality of artificial intelligences, on the basis of information relevant to the area of specialty of the artificial intelligence. For example, there are an artificial intelligence which is good at driving a vehicle, an artificial intelligence which is good at conversation with a person, and the like, and thus, the user is capable of selecting an artificial intelligence according to the object, from the plurality of artificial intelligences. Even in this case, the AI identification processing is executed with respect to the artificial intelligence selected by the user, and thus, it is possible to determine whether or not the artificial intelligence selected by the user is the authenticated artificial intelligence.

### Modified Example 3

In the embodiment described above, in a case where notification of the identification result about the artificial intelligence which is the communication partner, is provided to the user, the notification of the identification result can be provided in various output modes. For example, in a case of performing communication between the user and the artificial intelligence only by the sound, the output control unit 55 is capable of outputting the contents of communication by immixing a noise such as a white noise, when the artificial intelligence is not identified as the authenticated artificial intelligence. Accordingly, in communication with respect to the artificial intelligence according to the sound, in general, it is possible to notify the user that it is not the same artificial intelligence as that of being subjected to communication. In addition, in a case of performing communication between the user and the artificial intelligence by the display screen, the output control unit 55 is capable of mixing a noise such as a stripe pattern to the display screen, or of allowing an expression or a complexion of a character, which is an agent of the artificial intelligence, to be different from a normal expression or complexion, when the artificial intelligence is not identified as the authenticated artificial intelligence. Accordingly, in communication with respect to the artificial intelligence according to the display screen, in general, it is possible to notify the user that it is not the same artificial intelligence as that of being subjected to communication.

### Modified Example 4

In the embodiment described above, the artificial intelligence which is the communication partner, is identified by performing authentication by using the authentication information, but the present invention is not limited thereto. For example, it may be determined whether or not the artificial intelligence which communicates with the user, is the artificial intelligence which is assumed as the communication partner, on the basis of the communication contents between the user and the artificial intelligence which is the communication partner, and notification of the determination result may be provided as the identification result. A written style of the response of the artificial intelligence, a style of a response sentence, concreteness of response contents, a difference in a response pattern, or the like can be comprehensively determined, and notification of a possibility of matching with the artificial intelligence which is assumed as the communication partner can be provided as the identification result, as an example. Accordingly, even in a case where the authentication information is not acquired, the user is capable of suitably identifying the artificial intelligence, and of suitably understanding which artificial intelligence is the artificial intelligence which is the execution target.

The information processing apparatus 1 configured as described above includes the AI identification unit 52 and the output control unit 55. The AI identification unit 52 identifies the communication-target artificial intelligence in the plurality of artificial intelligences. The output control unit 55 notifies the user of the identification result about the artificial intelligence. Accordingly, the communication-target artificial intelligence is capable of identifying whether or not it is the artificial intelligence which is assumed as the communication target. In addition, the identification result about the communication-target artificial intelligence is output by the predetermined output method, and thus, notification can be provided to the user. Therefore, it is possible to suitably identify the artificial intelligence, and to suitably understand which artificial intelligence is the artificial intelligence which is the execution target.

In addition, the information processing apparatus 1 includes the AI selection unit 51 and the communication processing unit 54. The AI selection unit 51 selects the communication-target artificial intelligence in the plurality of artificial intelligences, on the basis of the manipulation of the user or the other artificial intelligence. The communication processing unit 54 executes the processing relevant to communication with the artificial intelligence selected by the AI selection unit 51. Accordingly, in the information processing apparatus 1, the artificial intelligence selected from the plurality of artificial intelligences, can be identified, and communication with respect to the identified artificial intelligence can be performed.

The AI identification unit 52 identifies the communication-target artificial intelligence on the basis of the name of the artificial intelligence and the attribute of the artificial intelligence. Accordingly, it is possible to identify the artificial intelligence by reflecting not only the name of the artificial intelligence but also more detailed attribute of the artificial intelligence.

The AI identification unit 52 identifies the communication-target artificial intelligence on the basis of the type of artificial intelligence and the learning history. Accordingly, even in the same artificial intelligence, in a case where the learning data or the learning algorithm is different, it is possible to identify the difference.

The AI identification unit 52 applies the identification information to the artificial intelligence which is the selection target, according to the AI selection unit 51. Accordingly, in the information processing apparatus 1, it is possible to easily select the plurality of artificial intelligences.

The output control unit 55 outputs response information from the communication-target artificial intelligence by the sound, and an output mode of the sound is changed on the basis of the identification result about the artificial intelligence according to the AI identification unit 52. Accordingly, in the communication with respect to the artificial intelligence according to the sound, it is possible to provide notification of the identification result.

The output control unit 55 outputs the response information from the communication-target artificial intelligence by the display screen, and an output mode of the display screen is changed on the basis of the identification result about the artificial intelligence according to the AI identification unit 52. Accordingly, in the communication with respect to the artificial intelligence according to the display screen, it is possible to provide notification of the identification result.

When the artificial intelligence provided in the information processing apparatus 1 performs communication with respect to the other artificial intelligence, the AI identification unit 52 identifies the other artificial intelligence. Accordingly, even in a case where the communication-target artificial intelligence is an invalid artificial intelligence by hacking or the like, the artificial intelligence provided in the information processing apparatus 1 is capable of identifying the artificial intelligence of the communication target.

The AI identification unit 52 determines a possibility that the artificial intelligence which is the communication target matches with the artificial intelligence which is assumed as the communication target, on the basis of the communication contents with respect to the artificial intelligence which is the communication target. The output control unit 55 provides notification of the possibility that the communication-target artificial intelligence matches with the artificial intelligence which is assumed as the communication target. Accordingly, even in a case where the attribute of the artificial intelligence which is subjected to communication is unclear, it is possible for the user to suitably identify the artificial intelligence.

Furthermore, the present invention is not limited to the embodiment described above, and modifications, improvements, and the like within a range where the object of the present invention can be attained, are included in the present invention. That is, the present invention can be widely applied to the information processing apparatus which identifies the communication-target artificial intelligence in the plurality of artificial intelligences, and notifies the user of the identification result about the artificial intelligence.

In addition, in the embodiment described above, the concept of the artificial intelligence includes various artificial intelligence technologies such as an artificial intelligence tool, an artificial intelligence program, and an artificial intelligence application. In addition, in the embodiment described above, generation information of the artificial intelligence may be included, as the attribute of the artificial intelligence. For example, in a case where the plurality of artificial intelligences are integrated, and a new artificial intelligence is generated, as the generation information of the artificial intelligence, the artificial intelligence of the integration source can be included in the generation information of the artificial intelligence as a parent generation. In addition, in the embodiment described above, the concept of identifying the artificial intelligence also includes a simple mode of identifying (distinguishing) each of the artificial intelligences by the name, the ID, or the like, in the plurality of artificial intelligences.

Although in the embodiment described above, a smartphone is adopted as an example for explaining the information processing apparatus 1 to which the present invention is applied, but the embodiment is not limited thereto. For example, the present invention can be applied to electronic devices in general that include an information processing function. For example, the present invention can be applied to a notebook type personal computer, a printer, a television receiver, a camcorder, a portable type navigation device, a cellular phone, a smartphone, a portable game device, and the like.

The processing sequence described above can be executed by hardware, and can also be executed by software. In other words, the functional configuration of FIG. 2 is merely illustrative examples, and the present invention is not particularly limited thereto. More specifically, the types of functional blocks employed to realize the above-described functions are not particularly limited to the examples shown in FIG. 2, so long as the information processing apparatus 1 can be provided with the functions enabling the aforementioned processing sequence to be executed in its entirety. A single functional block may be constituted by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multiprocessor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like. The computer may be a computer equipped with dedicated hardware. In addition, the computer may be a computer capable of executing various functions, e.g., a general purpose personal computer, by installing various programs.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 1 in which the program is recorded, and a semiconductor memory included in the storage unit 19 of FIG. 1, and the like.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

1-12. (canceled)

13. An information processing apparatus comprising:
a processor; and
a memory,
wherein the processor executes a program stored in the memory to perform operations comprising:
identifying an artificial intelligence; and
notifying a user of an identification result about the artificial intelligence.

14. The information processing apparatus according to claim 13, wherein the processor is further configured to select the artificial intelligence which becomes the target of the identification from among a plurality of artificial intelligences, on the basis of a manipulation of the user or another artificial intelligence.

15. The information processing apparatus according to claim 14, wherein:
selecting the artificial intelligence further comprises selecting the artificial intelligence from among a plurality of artificial intelligences including artificial intelligences which are not identified at a point of selection; and
identifying the artificial intelligence further comprises:
identifying a selected artificial intelligence when the selected artificial intelligence is not yet identified; and
identifying again a selected artificial intelligence when the selected artificial intelligence is already identified.

16. The information processing apparatus according to claim 13, wherein identifying the artificial intelligence further comprises identifying the artificial intelligence on the basis of a name of the artificial intelligence and an attribute of the artificial intelligence.

17. The information processing apparatus according to claim 13, wherein identifying the artificial intelligence further comprises identifying the artificial intelligence on the basis of a type of the artificial intelligence and a learning history.

18. The information processing apparatus according to claim 13, wherein identifying the artificial intelligence further comprises identifying the artificial intelligence on the basis of learning data and a learning algorithm which is used for learning by the artificial intelligence, a developer of the artificial intelligence, a version of the artificial intelligence or an artificial intelligence platform on which the artificial intelligence is based.

19. The information processing apparatus according to claim 16, wherein the memory is further configured to:
store a name and attributes of the artificial intelligence as specific information which is used in artificial intelligence authentication; and
wherein identifying the artificial intelligence further comprises determining whether the artificial intelligence matches with the authentication information of the artificial intelligence which is stored in the memory and was authenticated in the past.

20. The information processing apparatus according to claim 14, wherein identifying the artificial intelligence further comprises applying identification information to the artificial intelligence which is a selection target selected by the processor.

21. The information processing apparatus according to claim 14, wherein the processor is further configured to perform processing relevant to communication with the artificial intelligence which is selected.

22. The information processing apparatus according to claim 13, wherein notifying the identification result further comprises outputting response information from the artificial intelligence as a sound, and changing an output mode of the output sound on the basis of the identification result about the identified artificial intelligence.

23. The information processing apparatus according to claim 13, wherein notifying the identification result further comprises outputting response information from the artificial intelligence on a display screen, and changing an output mode of the display on the display screen on the basis of the identification result about the identified artificial intelligence.

24. The information processing apparatus according to claim 19, wherein notifying the identification result further comprises outputting response information from the artificial intelligence as a sound, and changing an output mode of the output sound on the basis of the determination result about the identified artificial intelligence.

25. The information processing apparatus according to claim 19, wherein notifying the identification result further comprises outputting response information from the artificial intelligence as a display, and changing an output mode of the output display on the basis of the determination result about the identified artificial intelligence.

26. The information processing apparatus according to claim 13, wherein identifying the artificial intelligence further comprises, when the artificial intelligence installed in the information processing apparatus communicates with another artificial intelligence, identifying the another artificial intelligence.

27. The information processing apparatus according to claim 13, wherein identifying the artificial intelligence further comprises determining a possibility that the artificial intelligence matches with an artificial intelligence which is assumed to be a communication target, on the basis of communication content with the artificial intelligence, wherein notifying the identification result further comprises providing notification of the possibility that the artificial intelligence matches with the artificial intelligence which is assumed to be a communication target.

28. An information processing apparatus comprising:
a processor; and
a memory,
wherein the processor executes a program stored in the memory to perform operations comprising:
identifying a communication-target artificial intelligence from among a plurality of artificial intelligences; and
notifying a user of an identification result about the communication-target artificial intelligence.

29. An information processing apparatus comprising:
a processor; and
a memory,
wherein the processor executes a program stored in the memory to perform operations comprising:
identifying a program for providing assistance to a user; and
notifying the user of an identification result.

30. An artificial intelligence identification method executed by an information processing apparatus including a processor, the artificial intelligence identification method causing the processor to execute a program stored in a memory to perform operations comprising:
identifying an artificial intelligence; and
notifying a user of an identification result about the artificial intelligence.

31. A non-transitory computer-readable storage medium storing a program that is executable by a computer that comprises a processor, the program being executable to cause the computer to perform operations comprising:
identifying an artificial intelligence; and
notifying a user of an identification result about the artificial intelligence.
